(19) United States
(12) Patent Application Publication
(10) Pub. No.: US 2009/0057346 A1
(43) Pub. Date: Mar. 5, 2009

(54) POWDER OR MILK POWDER DISPENSER

(76) Inventor: Soo Jin JANG, Namyangju-si (KR)

Correspondence Address: ROTHWELL, FIGG, ERNST & MANBECK, P.C., 1425 K STREET, N.W., SUITE 800, WASHINGTON, DC, 20005, US

(21) Appl. No.: 11/850,959

(22) Filed: Sep. 6, 2007

(30) Foreign Application Priority Data
Aug. 30, 2007 (KR) 10-2007-0087689

(51) Int. Cl. G01F 11/10

(52) U.S. Cl. 222/362

(57) ABSTRACT

Provided is a powder or milk powder dispenser comprising a milk powder container 7 for storing milk powder (or powder); a dispenser body installed at a lower end of the milk powder container 7, and discharging an amount of milk powder corresponding to a capacity of a milk powder-measuring cup 20 mounted inside the dispenser tray when a tray handle 21 is moved to one side direction and charging an amount of milk powder by an inflow of milk powder in the milk powder container 7 into the milk powder-measuring cup 20 when the tray handle 21 is returned to the original position; and a dispenser bottom-front 15, 16 installed at a lower end of the dispenser body and discharging the milk powder from the dispenser body to a carrying case 30 or an inlet of a milk bottle. The powder or milk powder dispenser of the present invention enables dispensing of a precise amount of powder to a carrying case or a milk bottle without using hands or spoons which may be exposed to a variety of pathogenic bacteria.

### RELATED APPLICATIONS

The present disclosure relates to subject matter contained in priority Korean Application No. 10-2007-0087689, filed on Aug. 30, 2007 which is herein expressly incorporated by reference in its entirety.

### BACKGROUND OF THE INVENTION

1. Field of the Invention

The present invention relates to a powder or milk powder dispenser. More specifically, the present invention relates to a powder or milk powder dispenser, which is capable of dispensing a precise amount of powder without using hands or spoons which may be exposed to a variety of pathogenic bacteria.

2. Description of the Related Art

Generally, infants are nourished with milk. Milk may be broadly divided into mother's milk and dairy milk (particularly purified and processed milk powder).

Even though breast feeding is recently encouraged due to a variety of known beneficial advantages, bottle-feeding may be inevitably included for the growth of babies and in some cases babies are brought up by bottle-feeding of formula milk from birth.

When it is desired to give milk powder to a baby during the infancy period, the baby's mother will select and purchase milk powder products that are thought to be adequate for the infancy period among various commercially available products of milk powder on the market. Most of commercially available milk powder products are fed to the baby by spooning an amount of milk powder into a milk bottle using a measuring spoon placed in a milk powder container, and then adding warm water to the milk, followed by stirring.

As such, the measuring spoon, which is placed in conjunction with milk powder in the powder milk container, is used directly with hands of the user upon bottle feeding of prepared formulas and is placed again together with milk powder in the milk powder container. Therefore, a handle of the measuring spoon held by the user contacts the milk powder, which is thus unsanitary and is responsible for the risk of propagation of pathogenic bacteria.

Particularly, when the milk powder container is full of milk powder, the measuring spoon is frequently embedded into the milk powder. In this case, the user puts his or her fingers into the milk powder to find the spoon. Therefore, hands of the user exposed to various pathogenic bacteria directly contact the milk powder being eaten by the baby, which is bad for the health of the baby and presents a problem of the risk associated with milk-borne transmission of various pathogens.

In order to overcome the problems discussed above, Korean Utility Model No. 20-0345436 discloses a spoon storage apparatus for a powdered milk can, which is intended for storage of the measuring spoon without contact with the milk powder after use of the spoon. However, this spoon storage apparatus is also configured within the milk powder container (can), so the problem of pathogenic infections, which may be caused by the measuring spoon, was not completely solved.

Further, similar to conventional milk powder products, the milk powder container which is provided with the spoon storage apparatus for a powdered milk can is packaged with placement of the measuring spoon on (or into) the milk powder. Therefore, when consumers purchase and open the product, the measuring spoon is usually buried in the milk powder. As a result, this system also suffers from the same problem that the user should put his or her fingers into the milk powder to find the spoon.

Further, because the spoon storage apparatus for a powdered milk can is installed inside the milk powder container even when the measuring spoon after use thereof is stored in the spoon storage apparatus for a powdered milk can, there is the risk of pathogenic transmission which may take place even without the direct contact of milk powder with the measuring spoon.

Further, if the milk powder container falls or inclines to one side even when the measuring spoon is stored in the spoon storage apparatus for powdered milk can, this may result in the contact of milk powder with the measuring spoon, thus causing transmission of various pathogenic bacteria.

Due to the aforementioned conventional problems, babies are further susceptible to the higher risk of pathogenic transmission by frequent use of the measuring spoon of the milk powder container as a result of frequent bottle feeding.

In addition, the baby should be fed with a precise amount of milk powder during an infancy period, otherwise the baby may suffer from diarrhea and constipation. However, the measuring spoon of commercially available milk powder products has a slightly different capacity depending upon milk powder manufacturers, so it is very difficult to adjust an accurate dose of milk powder. Further, most of the users who feed the baby with the milk powder usually prepare milk powder solutions only depending upon the number of times of spooning without paying significant attention to the capacity of the measuring spoon. Therefore, they fail to adjust the precise dose of milk powder which is necessary for the baby. Further, when the baby meal is formulated using the measuring spoon, milk powder may be occasionally spilled due to carelessness of the user.

Therefore, because the capacity of the measuring spoon varies with slight errors from manufacturer to manufacturer, when it is desired to scoop milk powder using the conventional measuring spoon, it is very difficult and troublesome to measure a precise amount of the milk powder. Further, combined storage of the measuring spoon in conjunction with the milk powder in the milk powder container always involves various problems associated with an unsanitary environment and the risk of transmission of various pathogenic bacteria.

### SUMMARY OF THE INVENTION

Therefore, the present invention has been made in view of the above problems, and it is an object of the present invention to provide a powder or milk powder dispenser, which is capable of measuring and dispensing a precise amount of a milk powder to a carrying case and a milk bottle without use of hands and a milk powder spoon.

It is another object of the present invention to provide a powder or milk powder dispenser, which is always capable of measuring and dispensing a constant and precise amount of a milk powder, irrespective of using any milk powder of various manufacturers.

It is a further object of the present invention to provide a powder or milk powder dispenser, which is configured to achieve easy assembly and disassembly to thereby allow easy washing of components.

It is another object of the present invention to provide a powder or milk powder dispenser, which is configured to measure and dispense a precise proper amount of a milk powder, by means of a rotating handle (tray handle)

It is yet another object of the present invention to provide a powder or milk powder dispenser having a semi-transparent milk powder container which is completely airtight to prevent penetration of moisture or foreign materials in the air or invasion of insects and is graduated to allow visual confirmation of the residual amount of milk powder.

It is another object of the present invention to provide a powder or milk powder dispenser having a plurality of carrying cases for dispensing, storing and carrying each single dose of milk powder and a carrying case holder for storing the carrying cases.

It is another object of the present invention to provide a powder or milk powder dispenser having a carrying case which has a small volume, an excellent durability, light weight and transparency, and therefore allows visual confirmation of the cleanliness and the residual amount of milk powder.

It is another object of the present invention to provide a powder or milk powder dispenser which can be dried using a carrying case holder after washing of a carrying case, due to the formation of a plurality of holes such that the carrying cases can be inserted reversely when the carrying case holder is turned upside down.

It is another object of the present invention to provide a powder or milk powder dispenser which has various soft color tones and is made of a non-fragile polypropylene material.

It is another object of the present invention to provide a powder or milk powder dispenser using a polyamide material that does not discharge a toxic substance even when it is disinfected in boiling water.

It is another object of the present invention to provide a powder or milk powder dispenser which can be used to measure and discharge a proper amount of a certain powdered material such as coffee, adlay (also called Job's-tear), uncooked food, food powder or drug powder, in addition to milk powder.

In accordance with the present invention, the above and other objects can be accomplished by the provision of a powder or milk powder dispenser comprising a milk powder container 7 for storing milk powder; a dispenser body installed at a lower end of the milk powder container 7, and discharging an amount of milk powder corresponding to a capacity of a milk powder-measuring cup 20 mounted inside the dispenser tray when a tray handle 21 is moved to one side direction and charging an amount of milk powder by an inflow of milk powder in the milk powder container 7 into the milk powder-measuring cup 20 when the tray handle 21 is returned to the original position; and a dispenser bottom-front 15, 16 installed at a lower end of the dispenser body and discharging the milk powder from the dispenser body to an inlet of a carrying case 30 or a milk bottle.

The dispenser body includes a cylindrical dispenser top cover 12 having a bottom surface 12e with a pipe shaft 12a and an outlet 12b integrally formed therein and having a tray handle movement slit 12c formed on the side thereof; a dispenser tray nozzle 14 installed at the lower part of the dispenser top cover 12 and having an outlet 14c provided at a position different from that of the outlet 12b of the dispenser top cover 12; a dispenser tray 13 charging/discharging the milk powder to the milk powder-measuring cup 20 while rotating between the outlet 12b of the dispenser top cover 12 and the outlet 14c of the dispenser tray nozzle 14 by the means of the tray handle 21 moving along the tray handle movement slit 12c; and a blade 11 installed at the upper part of the dispenser top cover 12 and mixing the milk powder of the milk powder container 7 by rotation of fans when the dispenser tray 13 rotates in one direction.

The dispenser top cover 12 includes a body 12d having has a cylindrical shape which is broad at the bottom and narrow on the top, space portions on the upper and lower parts being integrally formed with a bottom surface 12e at an inner central part, a pipe shaft 12a protrusively formed at the center of the upper and lower parts of the bottom surface 12e wherein the shaft formed at the lower part is partially incised with the formation of an inward screw, an outlet 12b formed on the bottom surface of one side of the pipe shaft 12a, a tray handle movement slit 12c lengthwise formed in a horizontal direction on the side of the body 12d, and inward protrusion portions of 12d in the body 12d opposite to the tray handle movement slit 12c.

The dispenser body may further include a circular dispenser top seal 18 which is ringed about the lower part of the outlet 12b of the dispenser top cover 12.

The dispenser tray 13 includes a circular body 13g having a shaft hole 13a at the center, a milk powder-measuring cup insertion hole 13d on one side and a tray handle insertion slot 13f on the rim of one side; a cylinder-shaped central shaft 13b positioned within the shaft hole 13a of the body 13g via integral connection of one side thereof to the body 13g, the ends and the inner part of one side being provided with a plurality of teeth 13c having a right triangle-shaped section and a screw; a cup placement groove 13h for safe placement of the milk powder-measuring cup 20 inside the milk powder-measuring cup insertion hole 13d; insertion slots 13e formed at two opposite sides of the cup placement groove 13h; and fixing grooves 13i formed on one side of the insertion slots 13e, wherein the central shaft 13b of the dispenser tray 13 is fitted into the pipe shaft 12a of the dispenser top cover 12 such that the dispenser tray 13 rotates in the right and left directions within the incised range of the shaft.

The milk powder-measuring cup 20 includes a circular horizontal plate 20b having an outlet formed at the center and having engaging protrusions 20a formed on both opposite sides; and a circular discharge pipe 20c integrally formed at the outlet in the direction vertical to the horizontal plate 20b, wherein the engaging protrusions 20a of the milk powder-measuring cup 20 are engaged into the insertion slots 13e of the dispenser tray 13 and the cup 20 is turned to be fixed into the fixing grooves 13i.

The blade 11 includes a first pipe shaft 11a having a plurality of fans 11d and a step portion 11f on one side; and a second pipe shaft 11b positioned in the inside of the first pipe shaft 11a via connection of the one side of the shaft 11b to the first pipe shaft 11a and having a plurality of teeth 11c having a right triangle-shaped section formed at an end of one side. Herein, the second pipe shaft 11b is inserted into the pipe shaft 12a of the dispenser top cover 12 such that the teeth 11c of the blade 11 are engaged with the right triangle-shaped teeth 13c formed on the central shaft 13b of the dispenser tray 13, so the right-angled parts (sides) of right triangle-shaped teeth 13c of the dispenser tray 13 rotate by engagement with inclined parts (sides) of the right triangle-shaped teeth 11c of the blade 11 when the dispenser tray 13 rotates in a first direction, and therefore the blade 11 is not rotated by the elastic force of a spring 10 installed inside a blade holder 9 and the frictional force with the milk powder of the milk powder container 7. When the dispenser tray 13 rotates in a second direction, the right-angled parts (sides) of right triangle-shaped teeth 13c of the dispenser tray 13 rotate while pushing right-angled parts (sides) of the right triangle-shaped teeth 11c of the blade 11.

The dispenser body may further include a spring 10 installed at the step portion 11f of the first pipe shaft 11a after insertion of the blade 11 into the pipe shaft 12a of the dispenser top cover 12; and a blade holder 9 for fixing the blade 11 and the dispenser tray 13 via connection of the blade 9 through the inside of the spring 10 and the first pipe shaft 11a to the central shaft 13b of the dispenser tray 13.

The tray handle 21 is inserted into the tray handle insertion slot 13f of the dispenser tray 13 via the tray handle movement slit 12c of the dispenser top cover 12 and is then fixed by inserting a tray handle fixing pin 24 into the fixing groove 21c of the tray handle 21.

The dispenser tray nozzle 14 includes a shaft hole 14a formed at the center for insertion of the nozzle into the pipe shaft 12a formed on the lower part of the dispenser top cover 12; a discharge funnel 14b formed on one side of the shaft hole 14a and guiding the milk powder discharged through the milk powder-measuring cup 20 to an outlet 23 of the dispenser bottom-front 15; a guide rail 14e for guiding a movement of the milk powder-measuring cup 20 mounted on the dispenser tray 13; and a position-fixing groove 14d for fixing a position of the nozzle 14 by insertion of the groove 14d into the protrusion 12d of the dispenser top cover 12, and may further include a dispenser tray holder 19 for connecting the nozzle to the pipe shaft 12a of the dispenser top cover 12 through the shaft hole 14a after installation of the dispenser tray nozzle 14.

The dispenser body is configured to have a structure that the milk powder charged in the milk powder-measuring cup 20 is discharged downwardly by allowing the milk powder-measuring cup 20 and the discharge funnel 14b of the dispenser tray nozzle 14 to be positioned coaxially to each other when the tray handle 21 is pushed in one side direction, and the milk powder is introduced into the milk powder-measuring cup 20 by allowing the milk powder-measuring cup 20 and the outlet 12b of the dispenser top cover 12 to be positioned coaxially to each other when the tray handle 21 is pulled to an original position in the other side direction, and the milk powder of the milk powder container is stirred by rotation of the blade 11 when the tray handle 21 rotates in one side direction or the other opposite direction.

The dispenser tray 13 discharges a given amount of the milk powder filled in the milk powder-measuring cup 20 while rotating between the outlet 12b of the dispenser top cover 12 and the discharge funnel 14b of the dispenser tray nozzle 14 in compliance with the rotation of the tray handle 21.

The milk powder container 7 is configured to have an open-topped and open-bottomed cylindrical structure made of a transparent colored material and has graduations on one side thereof. The upper part of the milk powder container 7 is sealed hermetically by a milk powder container cap 5 with an O-ring and the lower part of the milk powder container 7 is sealed hermetically with the dispenser top cover 12 by a milk powder container seal 8.

The dispenser bottom-front 15, 16 includes a front side 15 and the rear side 16 of the dispenser bottom-front which are screw-fastened after fitting the lower ends of the front side 15 and the rear side 16 into a dispenser bottom cover 17, wherein the front side 15 of the dispenser bottom-front includes an installation stand 15f having a guide groove for guiding the carrying case 30 such that the inlet of the carrying case 30 is in line with the dispenser outlet 15d, and the dispenser outlet 15d for discharging milk powder into the inlet of the carrying case 30 installed on the installation stand 15f.

The dispenser bottom-front 15, 16 may further include a cover installation stand 15e protrusively formed on both sides of the dispenser outlet 15d and a dispenser outlet cover 25 installed on the cover installation stand 15e for plugging the dispenser outlet 15d.

The carrying case 30 includes a carrying case top 2 having an inlet for injecting milk powder, a carrying case bottom 3 being detachably fitted into the carrying case top 2 and having insertion slots 3a formed on both sides, and a carrying case cap 1 for stopping the inlet of the carrying case top 2.

The aforesaid powder or milk powder dispenser is configured to have an open-topped quadrilateral box-like structure, wherein the lower surface has a plurality of shaft holes 4b, the dispenser includes a carrying case holder 4 having a plurality of protrusions 4a formed at regular intervals in both inner sides of the box. When the carrying case 30 is stored in the carrying case holder 4, an insertion groove 3a of the carrying case 30 is fitted into the protrusion 4a of the carrying case holder 4. When it is desired to wash the carrying case 30, the carrying case holder 4 is reversed such that the shaft hole 4b of the carrying case holder 4 is faced upward, the washed carrying case 30 is reversely fitted into the shaft hole 4b, followed by drying.

The powder or milk powder dispenser is made of a polyamide material that does not discharge a toxic substance even when it is disinfected in boiling water.

The milk powder-measuring cup 20 is configured to comply with the capacity of the milk powder spoon of milk powder manufacturers, and the capacity of the milk powder-measuring cup 20 corresponds to a spoonful of the milk powder spoon of milk powder manufacturers.

The capacity of the milk powder-measuring cup 20 corresponds to a single dose of the milk powder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a powder or milk powder dispenser;

FIG. 2 is an exploded perspective view of a powder or milk powder dispenser;

FIGS. 3A and 3B are a schematic view and a perspective view of a carrying case and a carrying case holder;

FIGS. 4A through 4D are explanatory diagrams illustrating how to use a carrying case and a carrying case holder;

FIGS. 5A through 5C are views of a dispenser top cover;

FIG. 5A is a perspective view showing an upper structure of a dispenser top cover;

FIG. 5B is a perspective view showing a front structure of a dispenser top cover;

FIG. 5C is a perspective view showing a lower structure of a dispenser top cover;

FIGS. 6A and 6B are perspective views showing upper and lower structures of a dispenser tray, respectively;

FIGS. 7A and 7B are perspective views showing upper and lower structures of a milk powder-measuring cup, respectively;

FIGS. 8A and 8B are perspective views showing upper and lower structures of a blade, respectively;

FIG. 9 is a perspective view of a blade holder;

FIG. 10 is a perspective view of a tray handle and a tray handle-fixing pin;

FIGS. 11A and 11B are perspective views showing upper and lower structures of a dispenser tray nozzle, respectively;

FIGS. 12A through 12I are views showing how to disassemble a powder or milk powder dispenser body and how to change a milk powder-measuring cup;

FIGS. 13A and 13B are configuration diagrams of a dispenser bottom-front;

FIGS. 14A and 14B are exploded views of a dispenser bottom-front;

FIGS. 15A and 15B are assembly views of a dispenser bottom-front and a dispenser top cover;

FIGS. 16A through 16C are assembly views of a dispenser top cover and a milk powder container;

FIGS. 17A through 17I are explanatory diagrams illustrating how to use a powder or milk powder dispenser in accordance with the present invention; and

FIG. 18 is a product photograph of a powder or milk powder dispenser.

### DETAILED DESCRIPTION OF THE PREFERRED EMBODIMENTS

Hereinafter, the present invention will be described in more detail with reference to the accompanying drawings.

A Powder or Milk Powder Dispenser

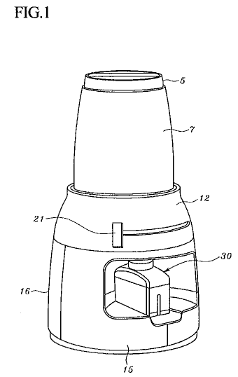

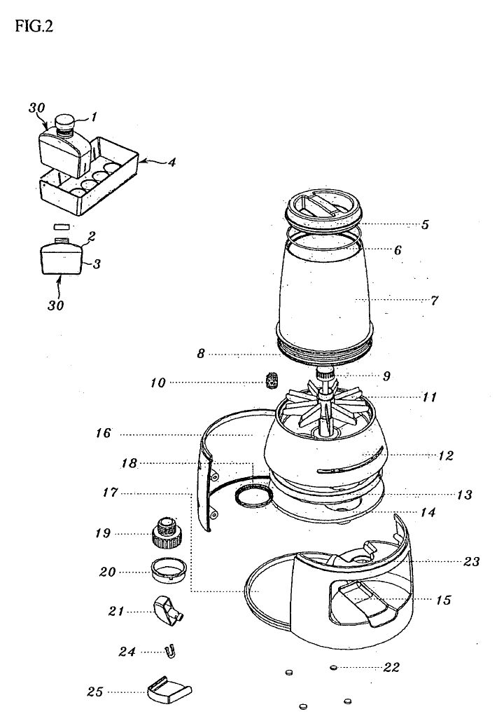

FIGS. 1 through 18 are views of the powder or milk powder dispenser according to a preferred embodiment of the present invention. FIG. 1 is a perspective view of a powder or milk powder dispenser and FIG. 2 is an exploded perspective view of a powder or milk powder dispenser.

As shown in FIGS. 1 and 2, the powder or milk powder dispenser according to the present invention includes a carrying case 30 having a carrying case cap 1, a carrying case top 2 and a carrying case bottom 3, a carrying case holder 4, a milk powder container cap 5, a milk powder container cap O-ring 6, a milk powder container 7, a milk powder container seal 8, a blade holder 9, a spring 10, a blade 11, a dispenser top cover 12, a dispenser tray 13, a dispenser tray nozzle 14, a dispenser bottom-front front side 15, a dispenser bottom-front rear side 16, a dispenser bottom cover 17, a dispenser top seal 18, a dispenser tray holder 19, a milk powder-measuring cup 20, a tray handle 21, a dispenser bottom cover packing 22, a dispenser outlet 15d, a tray handle fixing pin 24, and a dispenser outlet cover 25.

Upon functionally reviewing the powder or milk powder dispenser having such a configuration, the device can be broadly divided into the milk powder container 7, the dispenser body, the dispenser bottom-front 15, 16, and the carrying case 30.

The milk powder container 7 serves to contain and store milk powder, and includes the milk powder container cap 5, the milk powder container cap O-ring 6, and the milk powder container seal 8.

The dispenser body is installed at the lower end of the milk powder container 7, and includes the blade holder 9, the spring 10, the blade 11, the dispenser top cover 12, the dispenser tray 13, the dispenser tray nozzle 14, the dispenser top seal 18, the dispenser tray holder 19, the milk powder-measuring cup 20, the tray handle 21, and the tray handle fixing pin 24. The dispenser body is operated to discharge an amount of milk powder corresponding to a capacity of the inside mounted milk powder-measuring cup 20 when the tray handle 21 is moved to one side direction and charge a given amount of milk powder by an inflow of milk powder in the milk powder container 7 into the milk powder-measuring cup 20 when the tray handle 21 is returned to the original position.

The dispenser bottom-front 15, 16 is installed at a lower end of the dispenser body and discharges the milk powder from the dispenser body to the inlet of the carrying case 30. The dispenser bottom-front 15, 16 includes the dispenser bottom cover 17, the dispenser outlet 15d, and the dispenser bottom cover packing 22.

The carrying case 30 is a milk powder-carrying case for dispensing, storing and carrying a single dose of the milk powder. The carrying case 30 is separated into the carrying case top 2 and the carrying case bottom 3 and includes the carrying case cap 1.

When the tray handle 21 is completely pushed to one side direction (for example, right side), the powder or milk powder dispenser having such a configuration in accordance with the present invention is operated in a manner that an amount of milk powder corresponding to the capacity of the milk powder-measuring cup 20 mounted on the dispenser tray 13 falls to the inside of the carrying case to thereby discharge a spoonful (or a single dose) of milk powder. On the other hand, when the tray handle 21 is pulled in the other side direction (for example, left side) to the original position, returning of the dispenser tray 13 to the original position leads to an inflow of milk powder in the milk powder container 7 into the milk powder-measuring cup 20 to thereby charge a spoonful (or a single dose) of milk powder. Therefore, the powder or milk powder dispenser of the present invention is capable of measuring and dispensing a precise amount of a milk powder to the carrying case without use of hands and a milk powder spoon.

Hereinafter, the construction and operational principle of the powder or milk powder dispenser of the present invention will be described in more detail with reference to the accompanying drawings.

Carrying Case 30 and Carrying Case Holder 4

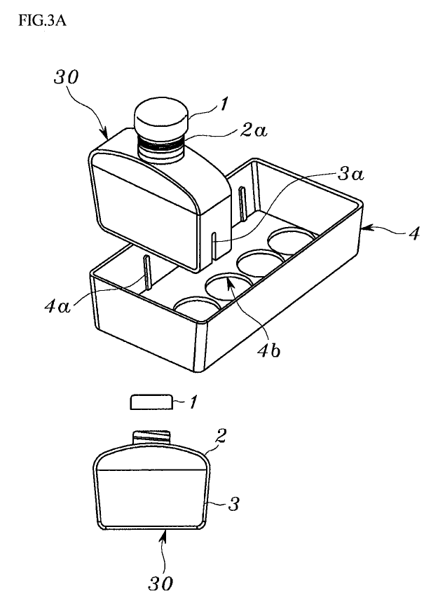

FIGS. 3A and 3B are a schematic view and a perspective view of a carrying case and a carrying case holder.

The carrying case 30 is a milk powder-carrying case for dispensing, storing and carrying a single dose of the milk powder. The carrying case 30 includes a carrying case top 2 having an inlet for injecting milk powder, a carrying case bottom 3 being detachably fitted into the carrying case top 2 and having insertion grooves 3a formed on both sides, and a carrying case cap 1 for stopping the inlet of the carrying case top 2.

The carrying case holder 4 serves to house and store the carrying case 30. As shown in FIGS. 3A and 3B, the carrying case holder 4 is configured to have an open-topped quadrilateral box-like structure and has a plurality of shaft holes 4b on the lower surface and a plurality of protrusions 4a formed at regular intervals inside both sides of the case box.

Preferably, the carrying case 30 and/or the carrying case holder 4 is made of a polyamide material that does not discharge a toxic substance even when it is disinfected in boiling water. Alternatively, the carrying case 30 and/or the carrying case holder 4 may be made of a polypropylene material which is not fragile, is light and transparent, and therefore allows visual confirmation of the cleanliness of the device. Further, the carrying case 30 and/or the carrying case holder 4 may be made to have transparent and soft color tones, thereby achieving diversity and improved design of products.

When it is desired to store the carrying case 30 in the carrying case holder 4, the carrying case 30 is fixed into the carrying case holder 4 by pushing the insertion groove 3a of the carrying case 30 into the protrusion 4a of the carrying case holder 4. When it is desired to take out the carrying case 30 from the carrying case holder 4, the carrying case 30 is pulled upward from the carrying case holder 4.

How to Use Carrying Case 30 and Carrying Case Holder 4

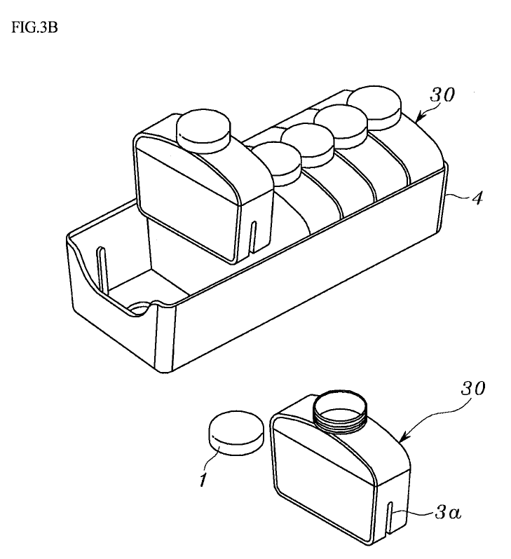

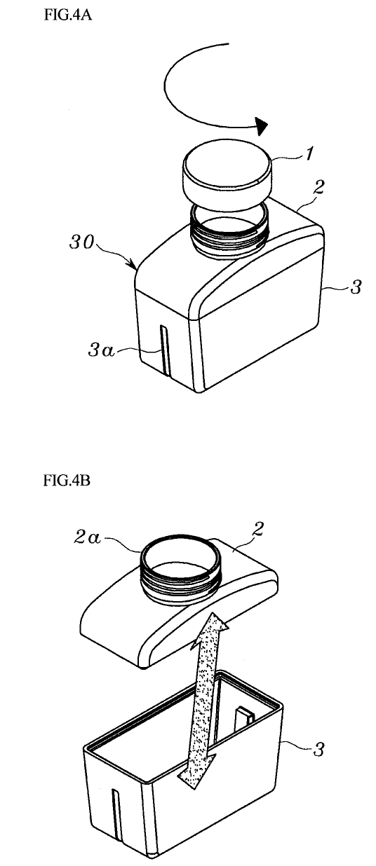

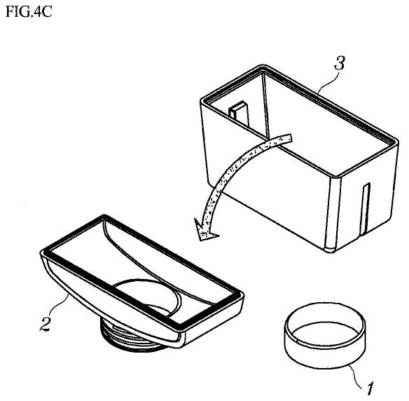

FIGS. 4A through 4D are explanatory diagrams illustrating how to use the carrying case and the carrying case holder.

First, as shown in FIGS. 4A through 4D, a carrying case cap 1 is separated from the carrying case 30 by turning the cap 1 anti-clockwise, followed by separation of a carrying case top 2 and a carrying case bottom 3. Alternatively, the carrying case cap 1 may also be separated after separation of the carrying case top 2 and the carrying case bottom 3.

Herein, the carrying case 30 is divided into the carrying case top 2 and the carrying case bottom 3 which are separated from each other by pulling these two parts apart. The separation of the carrying case 30 into the carrying case top 2 and the carrying case bottom 3 is intended for easy washing of the inside of the carrying case 30.

As shown in FIG. 4D, the carrying case holder 4 is provided with a plurality of shaft holes 4b such that the carrying case 30 can be inserted reversely when the carrying case holder 4 is turned upside down. When the washed carrying case 30 is reversely fitted into the shaft hole 4b of the carrying case holder 4, followed by putting the assembly structure with the bottom up, water adhered to the inside and outside of the carrying case 30 upon washing thereof flows downward to thereby provide an advantage of convenient and clean drying. Further, the carrying case holder 4 is provided with the formation of a plurality of shaft holes 4b, so it is possible to wash and dry a plurality of carrying cases 30.

Hereinafter, the construction and operational principle of the powder or milk powder dispenser in accordance with the present invention will be described in more detail with reference to the accompanying drawings.

Dispenser Top Cover 12

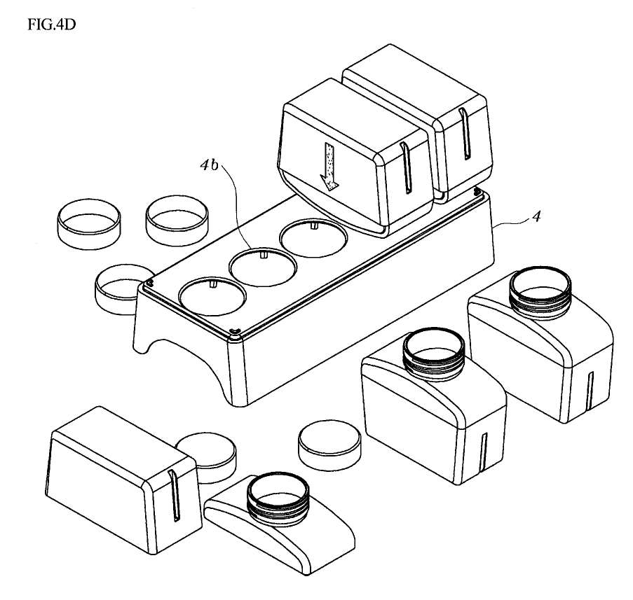

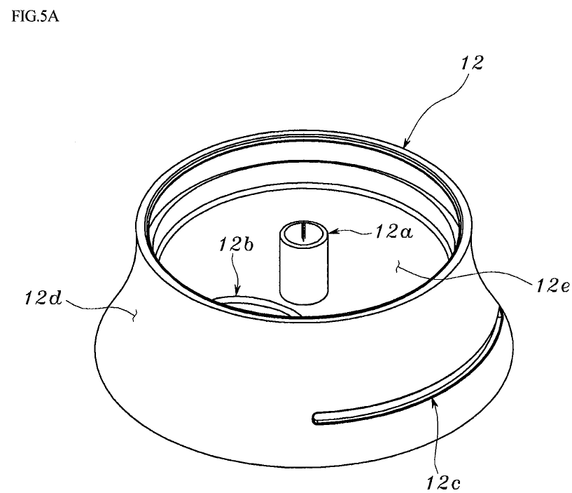

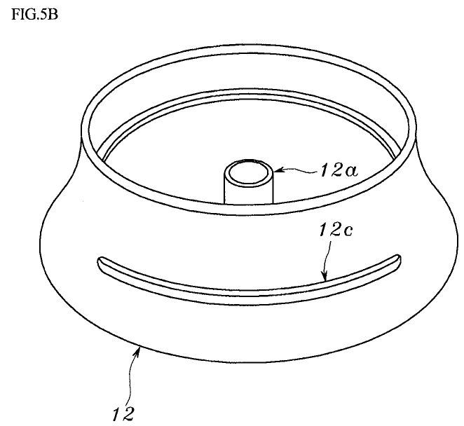

FIGS. 5A through 5C are views of the dispenser top cover 12. Specifically, FIG. 5A is a perspective view showing an upper structure of a dispenser top cover, FIG. 5B is a perspective view showing a front structure of a dispenser top cover, and FIG. 5C is a perspective view showing a lower structure of a dispenser top cover.

The dispenser top cover 12, as shown in FIGS. 5A to 5C, includes a body 12d having a cylindrical shape which is narrow at the bottom and broad on the top, space portions on the upper and lower parts being integrally formed with a bottom surface 12e at an inner central part, a pipe-shaped shaft 12a protrusively formed at the center of the upper and lower parts of the bottom surface 12e wherein the shaft formed at the lower part is partially incised with the formation of an inward, an outlet 12b formed on the bottom surface of one side of the pipe shaft 12a, a tray handle movement slit 12c lengthwise formed in a horizontal direction on the side of the body 12d, and inward protrusion portions 12d formed in the body 12d opposite to the tray handle movement slit 12c.

The outlet 12b formed portion inside the dispenser top cover 12 is provided with the formation of a protrusion conforming to a shape of the outlet 12b, and a circular dispenser top seal 18 is ringed about the protrusion portion. The circular dispenser top seal 18 serves to prevent leakage of milk powder through a gap between the outlet 12b and the milk powder-measuring cup 20, when the dispenser tray 13 is assembled with mounting of the milk powder-measuring cup 20 in the dispenser top cover 12.

Dispenser Tray 13

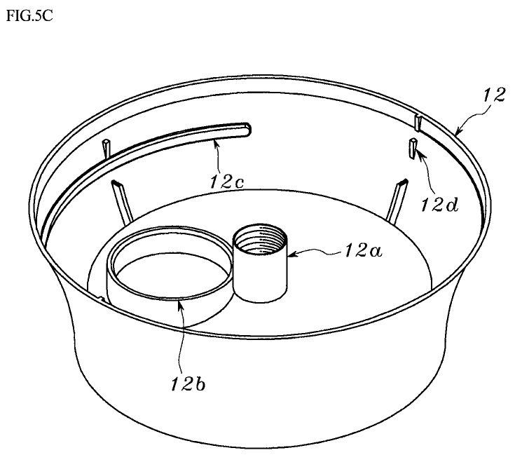

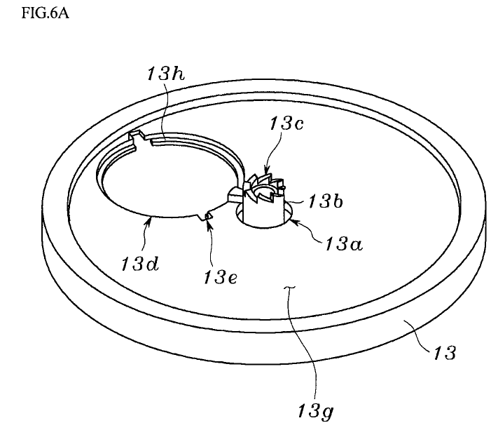

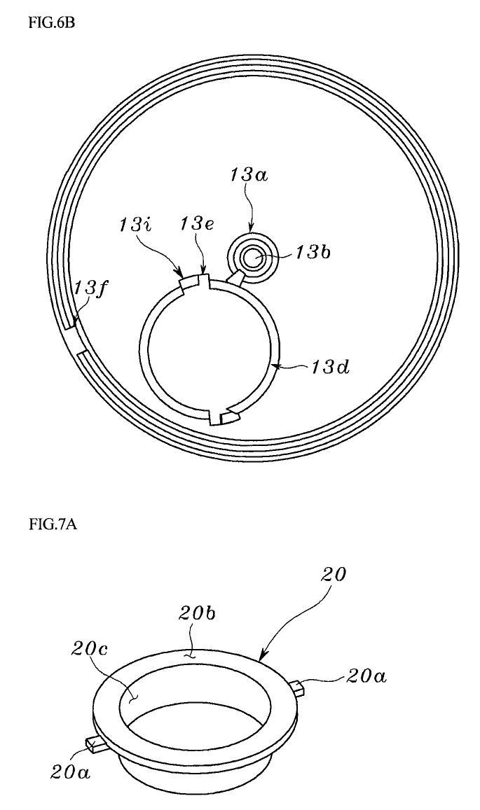

FIGS. 6A and 6B are perspective views showing upper and lower structures of the dispenser tray 13, respectively.

The dispenser tray 13, as shown in FIGS. 6A and 6B, includes a circular body 13g having a shaft hole 13a at the center, a milk powder-measuring cup insertion hole 13d on one side integrally formed with a tray handle insertion slot 13f on the rim of one side; and a cylinder-shaped central shaft 13b positioned within a shaft hole 13a of the body 13g via integral connection of one side thereof to the body 13g, the inner part and the ends of one side being provided with a screw and a plurality of teeth 13c having a right triangle-shaped section, the body 13g and the shaft 13b being formed integrally.

Further, the dispenser tray 13, as shown in FIGS. 6A and 6B, further includes a cup placement groove 13h for safe placement of the milk powder-measuring cup inside the milk powder-measuring cup insertion hole 13d, insertion slots 13e formed at two opposite sides of the cup placement groove 13h, and fixing grooves 13i formed on one side of the insertion slots 13e.

The dispenser tray 13 is assembled to rotate in the right and left directions within the incised range of the pipe shaft 12a of the dispenser top cover 12 by fitting the central shaft 13b with the formation of teeth 13c into the pipe shaft 12a at the lower portion of the dispenser top cover 12.

Therefore, the dispenser tray 13 serves to charge/discharge the milk powder to the milk powder-measuring cup 20 while rotating between the outlet 12b of the dispenser top cover 12 and the outlet 14c of the dispenser tray nozzle 14, by the means of the tray handle 21 moving along the tray handle movement slit 12c.

Milk Powder-Measuring Cup 20

FIGS. 7A and 7B are perspective views showing upper and lower structures of the milk powder-measuring cup 20, respectively.

As shown in FIGS. 7A and 7B, the milk powder-measuring cup 20 includes a circular horizontal plate 20b having an outlet formed at the center and having engaging protrusions 20a formed on lower ends of both opposite sides, and a circular discharge pipe 20c at the outlet in a direction vertical to the horizontal plate 20b, the cup 20 and pipe 20c which are integrally formed.

The milk powder-measuring cup 20 is fixed by fitting the engaging protrusions 20a of the milk powder-measuring cup 20 into the insertion slots 13e of the dispenser tray 13 and turning the cup 20 to be fixed into the fixing grooves 13i.

The milk powder-measuring cup 20 having such a configuration in accordance with the present invention is structured to have an adjusted size of the outlet depending upon the capacity of the milk powder spoon of milk powder manufacturers, and the capacity of the milk powder-measuring cup 20 corresponds to a spoonful of the milk powder spoon of milk powder manufacturers.

Therefore, the powder or milk powder dispenser in accordance with the present invention provides an additional dose-measuring device in compliance with milk powder manufacturers (including domestic and foreign manufacturers) and a plurality of the milk powder-measuring cups 20 corresponding to the capacity of the milk powder spoon of individual milk powder manufacturers. As a result, the user may install and use the milk powder-measuring cup 20, which corresponds to a spoonful of the milk powder spoon of the purchased milk powder product into the dispenser tray 13 of the powder or milk powder dispenser.

In another embodiment of the present invention, the milk powder-measuring cup 20 may be prepared to have the capacity corresponding to a single dose of milk powder. In this connection, the milk powder-measuring cup 20 is provided in a plurality of cups 20 with different capacities, such that the user can select an amount of milk powder to feed the baby. Accordingly, the user can fill a single dose of milk powder to feed the baby into the carrying case 30 or the milk bottle, only by a single manipulation involving pushing of the tray handle 21 to one side direction (for example, right side) and returning the tray handle 21 in the other side direction (for example, left side) to the original position.

Blade 11

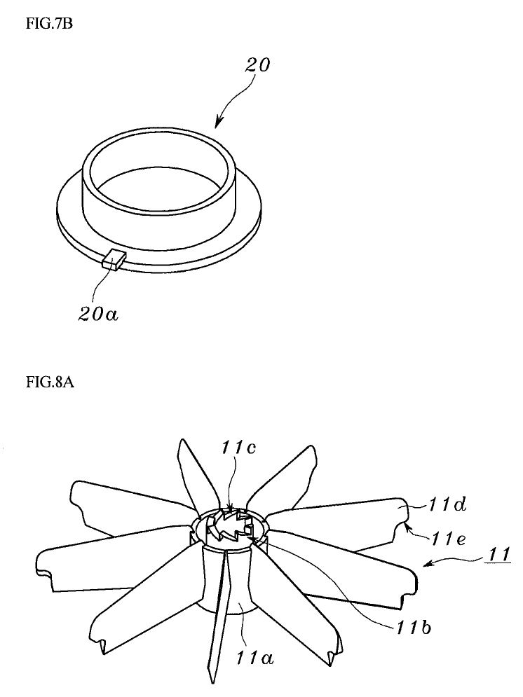

FIGS. 8A and 8B are perspective views showing upper and lower structures of a blade, respectively.

As shown in FIGS. 8A and 8B, the blade 11 includes a first pipe shaft 11a having a plurality of fans 11d and a step portion 11f on one side; and a second pipe shaft 11b positioned in the inside of the first pipe shaft 11a via integral connection of the one side of the shaft 11b to the first pipe shaft 11a and having a plurality of teeth 11c having a right triangle-shaped section formed at an end of the other side.

The blade 11 is installed in a manner that the second pipe shaft 11b is inserted into the pipe shaft 12a of the dispenser top cover 12 such that the teeth 11c of the blade 11 are engaged with the right triangle-shaped teeth 13c formed on the central shaft 13b of the dispenser tray 13.

In this manner, the right-angled parts (sides) of right triangle-shaped teeth 13c of the dispenser tray 13 rotate by engagement with inclined parts (sides) of the right triangle-shaped teeth 11c of the blade 11 when the dispenser tray 13 rotates in a first direction. At this time, the blade 11 is not rotated by the downward-pushing elastic force of a spring 10 connected to the inside of the blade holder 9 and by the frictional force with the milk powder of the milk powder container 7.

On the other hand, when the dispenser tray 13 rotates in a second direction, the right-angled parts (sides) of right triangle-shaped teeth 13c of the dispenser tray 13 rotate the blade 11 while pushing right-angled parts (sides) of the right triangle-shaped teeth 11c of the blade 11. At this time, the blade 11 stirs milk powder contained in the milk powder container 7 while rotating, thus preventing solidification of the milk powder. At the same time, the blade 11 assists in falling of a spoonful or a single dose of milk powder into the milk powder-measuring cup 20.

Blade Holder 9

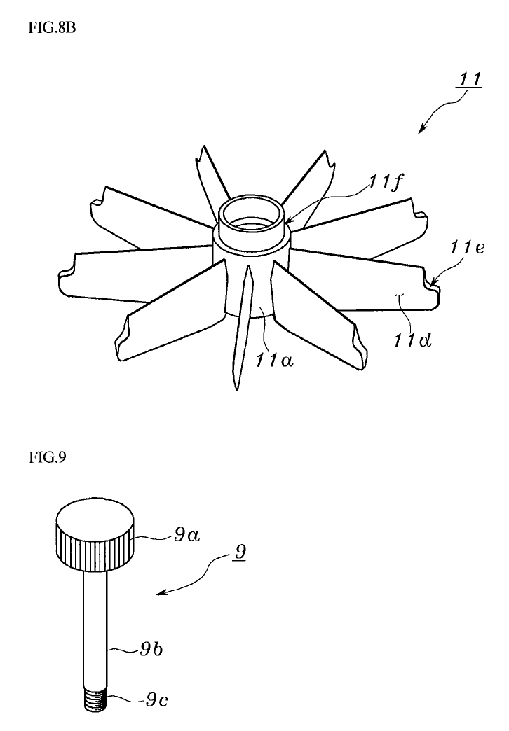

FIG. 9 is a perspective view of a blade holder 9.

As shown in FIG. 9, the blade holder 9 includes a shaft 9b with a screw 9c integrally formed at one side end, and a holder head 9a formed at the other end of the shaft 9b to loosen or tighten the screw 9c.

First, the blade 11 is fitted into the pipe shaft 12a of the dispenser top cover 12, and the spring 10 is then ringed about the step portion 11f of the first pipe shaft 11a of the blade 11. Thereafter, the blade holder 9 is fitted into the spring 10 and the first pipe shaft 11a, and the screw formed inside the central shaft 13 of the dispenser tray 13 is engaged with the screw 9c of the blade holder 9, so the blade 11 and the dispenser tray 13 are fixed.

Tray Handle 21 and Tray Handle Fixing Pin 24

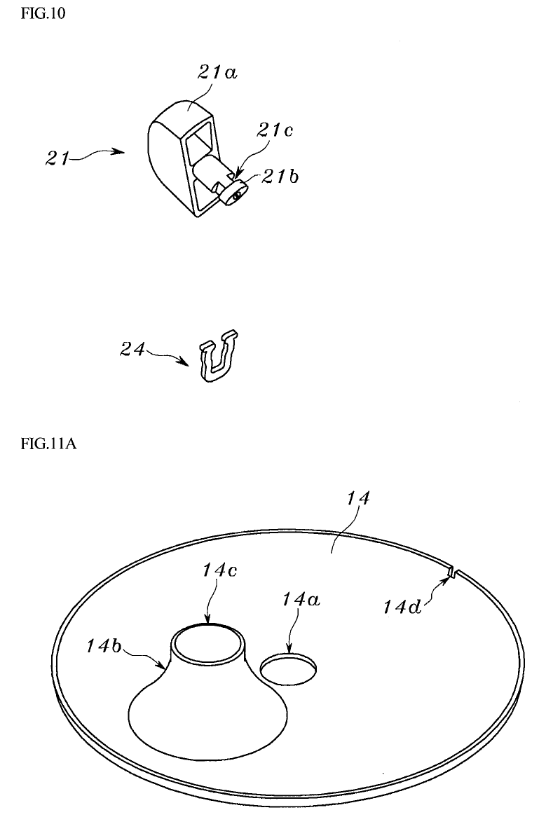

FIG. 10 is a perspective view of the tray handle 21 and the tray handle-fixing pin 24.

As shown in FIG. 10, the tray handle 21 includes a handle part 21a, and a fitting part 21b protrusively formed on one side of the handle part 21a and integrally formed with a fitting groove 21c. The tray handle fixing pin 24 is configured to be fixed by fitting the pin 24 into the fitting groove 21c of the tray handle 21. For example, the tray handle fixing pin 24 is preferably configured to have a U-shape.

The tray handle 21 is installed by inserting the fitting part 21b into the tray handle insertion slot 13f of the dispenser tray 13 via the tray handle movement slit 12c of the dispenser top cover 12.

Then, the tray handle 21 is fixed by inserting the tray handle fixing pin 24 into the fixing groove 21c of the tray handle 21 inserted into the tray handle insertion slot 13f of the dispenser tray 13.

Dispenser Tray Nozzle 14

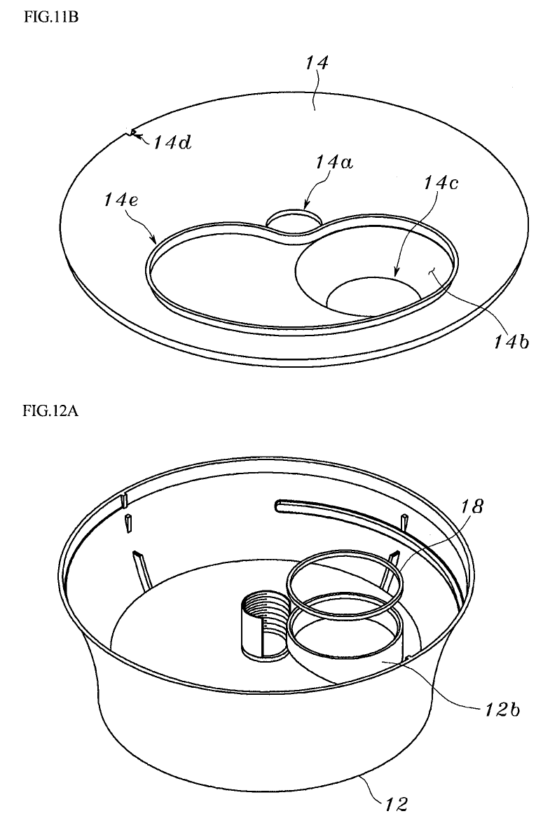

FIGS. 11A and 11B are perspective views showing upper and lower structures of a dispenser tray nozzle 14, respectively.

As shown in FIGS. 11A and 11B, the dispenser tray nozzle 14 includes a shaft hole 14a formed at the center for insertion of the nozzle into the pipe shaft 12a formed on the lower part of the dispenser top cover 12; a discharge funnel 14b formed on one side of the shaft hole 14a and guiding the milk powder discharged through the milk powder-measuring cup 20 to an outlet 23 of the dispenser bottom-front 15; a guide rail 14e for guiding a movement of the milk powder-measuring cup 20 mounted on the dispenser tray 13; and a position-fixing groove 14d for fixing a position of the dispenser tray nozzle 14 by insertion of the groove 14d into the protrusion 12d of the dispenser top cover 12.

The dispenser tray nozzle 14 is fixed by fitting the shaft hole 14a of the dispenser tray nozzle 14 into the pipe shaft 12a of the dispenser top cover 12, fitting the position-fixing groove 14d into the protrusion 12d of the dispenser top cover 12 to thereby fix a position of the dispenser tray nozzle 14, and then connecting the dispenser tray holder 19 to the pipe shaft 12a of the dispenser top cover 12.

How to Disassemble Powder or Milk Powder Dispenser Body and how to Change Milk Powder-Measuring Cup

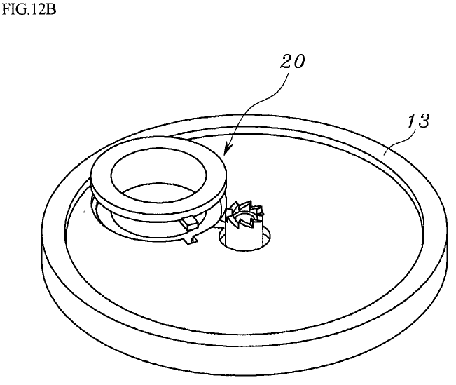

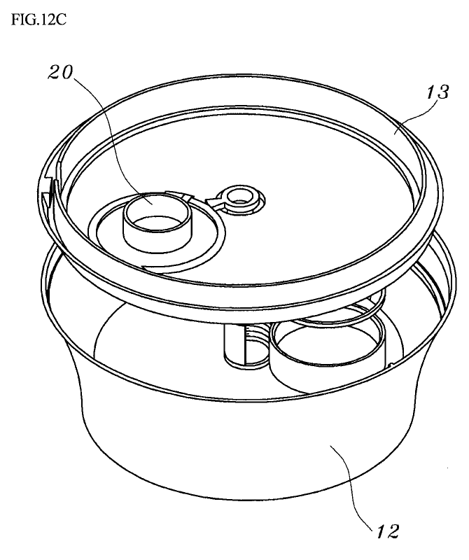

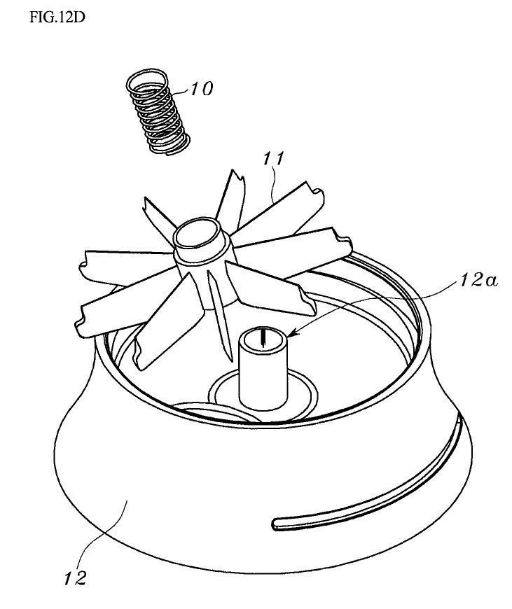

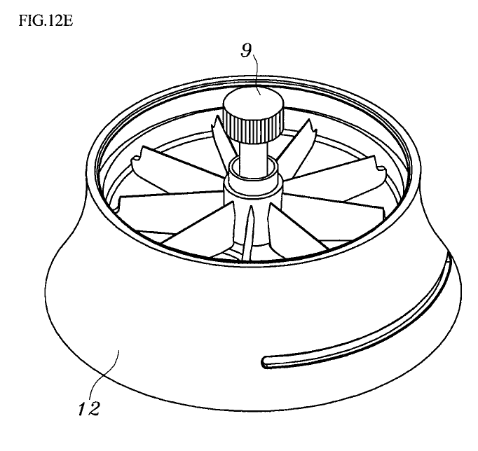

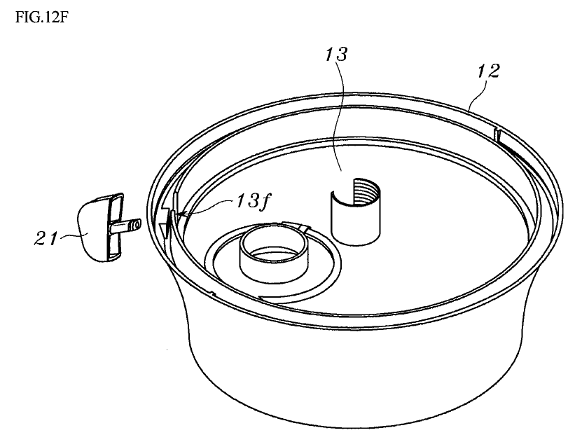

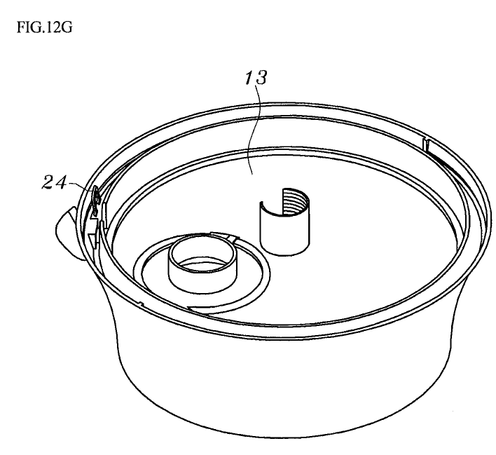

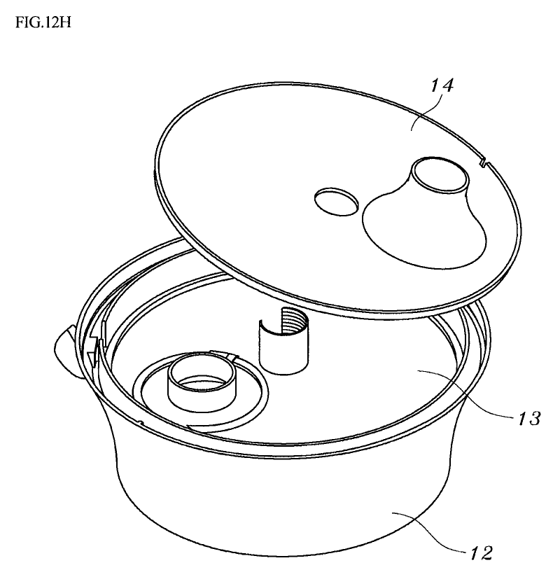

FIGS. 12A through 121 are assembly views showing how to disassemble a powder or milk powder dispenser body and how to change a milk powder-measuring cup.

First, as shown in FIG. 12A, a circular dispenser top seal 18 is ringed about the protruded portion conforming to a shape of the outlet 12b inside the dispenser top cover 12.

Then, as shown in FIG. 12B, the milk powder-measuring cup 20 is fitted into the dispenser tray 13. In this connection, the milk powder-measuring cup 20, as described before, consists of a plurality of the cups having different outlet sizes to comply with the capacity of the milk powder spoon of milk powder manufacturers. Therefore, the milk powder-measuring cup 20 is installed which corresponds to the capacity of the milk powder spoon of the milk powder manufacturer to be used.

Next as shown in FIG. 12C, the dispenser tray 13 with installation of the milk powder-measuring cup 20 is fitted into the pipe shaft at the lower part of the dispenser top cover 12.

Thereafter, as shown in FIGS. 12D and 12e, the blade 11 is fitted into the pipe shaft at the upper part of the dispenser top cover 12, followed by fitting of the spring 10 and the blade holder 9.

Next, as shown in FIGS. 12F and 12G, the tray handle 21 is inserted into the tray handle insertion slot 13f of the dispenser tray 13 via the tray handle movement slit 12c of the dispenser top cover 12 and the tray handle fixing pin 24 is fitted into the fixing groove 21c of the tray handle 21.

Next, as shown in FIG. 12H, the dispenser tray nozzle 14 is inserted into the pipe shaft 12a at the lower part of the dispenser top cover 12. Herein, the dispenser tray nozzle 14 is position-fixed by fitting the shaft hole 14a into the pipe shaft 12a at the lower part of the dispenser top cover 12 and then fitting the position-fixing groove 14d into the protrusion 12d of the dispenser top cover 12.

Finally, as shown in FIG. 12I, the dispenser tray nozzle 14 is fixed into the dispenser top cover 12 by connecting the dispenser tray holder 19 to the pipe shaft 12a of the dispenser top cover 12.

In the aforesaid configuration, the dispenser body is adapted to have a structure that the milk powder charged in the milk powder-measuring cup 20 is discharged downwardly by allowing the milk powder-measuring cup 20 and the discharge funnel 14b of the dispenser tray nozzle 14 to be positioned coaxially to each other when the tray handle 21 is pushed in one side direction, and the milk powder is introduced into the milk powder-measuring cup 20 by allowing the milk powder-measuring cup 20 and the outlet 12b of the dispenser top cover 12 to be positioned coaxially to each other when the tray handle 21 is pulled to an original position in the other side direction. Further, the blade 11 is allowed to rotate so as to stir the milk powder of the milk powder container, thus preventing solidification of the milk powder when the tray handle 21 rotates in one side direction.

Dispenser Bottom-Front 15, 16

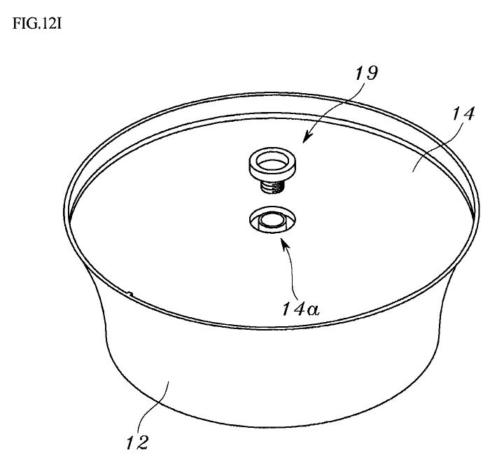

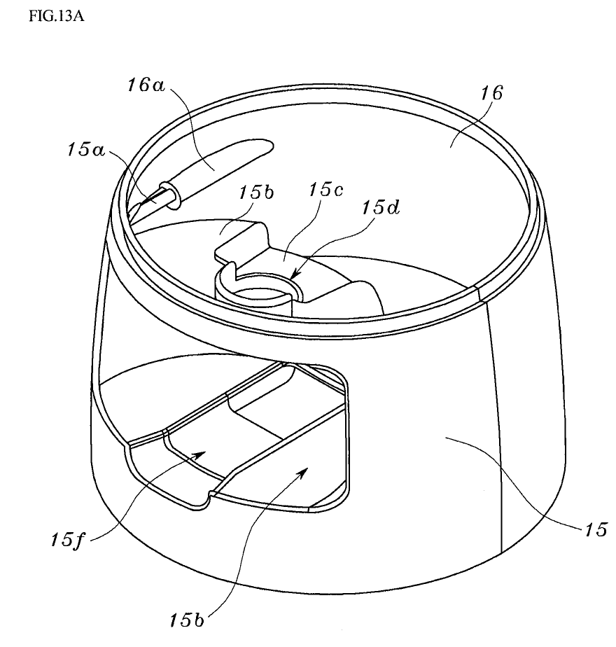

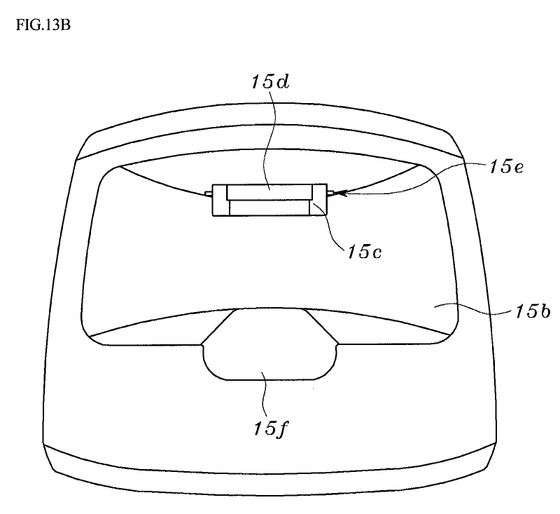

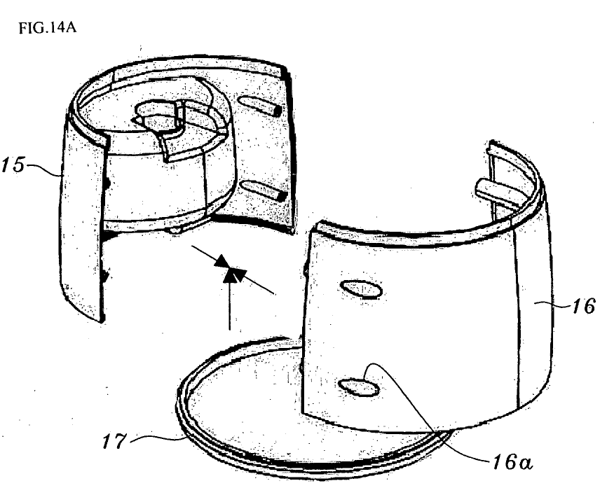

FIGS. 13A and 13B are configuration diagrams of a dispenser bottom-front 15, 16, and FIGS. 14A and 14B are exploded views of a dispenser bottom-front 15, 16.

As shown in FIGS. 14A and 14B, the dispenser bottom-front 15, 16 includes a front side 15 and the rear side 16 of the dispenser bottom-front which are screw-fastened after fitting the lower ends of the front side 15 and the rear side 16 into a dispenser bottom cover 17.

As shown in FIGS. 13A and 13B, the dispenser bottom-front 15 has a space portion 15b formed in the front portion, the upper side of the space portion 15b has an installation stand 15f for installing the carrying case 30 integrally formed therein, and the lower side of the space portion 15b has the dispenser outlet 15d for discharging milk powder into the inlet of the carrying case 30 installed on the installation stand 15f.

The installation stand 15f has a guide groove for guiding the carrying case 30 integrally formed therein, such that the inlet of the carrying case 30 is in line with the dispenser outlet 15d. The cover-fitting portions 15e for installation and release of the dispenser outlet cover 25 are integrally formed on both sides of the dispenser outlet 15d.

When the powder or milk powder dispenser is not used, the dispenser outlet cover 25 is fitted into the cover-fitting portions 15e to close the dispenser outlet 15d.

Another Embodiment of Dispenser Bottom-Front 15, 16

According to the present invention, the dispenser bottom-front 15, 16 may be modified to have another configuration such that the carrying case 30 and the milk bottle can be used together.

1) As one embodiment, the powder or milk powder dispenser in accordance with the present invention has a milk bottle-installation stand in the front portion of the dispenser bottom-front 15, the stand being integrally formed with the dispenser bottom-front 15, and a carrying case-installation stand on the milk bottle-installation stand, the carrying case-installation stand sliding into the inside of the dispenser bottom-front 15, 16. The carrying case-installation stand is configured such that it slides into the inside of the dispenser bottom-front 15, 16. The milk bottle-installation stand is provided with a guide groove integrally formed therein, such that the inlet of the milk bottle is in line with the dispenser outlet 15d. The carrying case-installation stand is provided with a guide groove integrally formed therein, such that the inlet of the carrying case is in line with the dispenser outlet 15d.

In the powder or milk powder dispenser, when it is desired to employ the carrying case, the carrying case is pushed into the carrying case-installation stand. When it is desired to employ the milk bottle, the carrying case is pushed into the inside of the dispenser bottom-front 15, 16 and the milk bottle is then installed into the milk bottle-installation stand.

2) As another embodiment, the powder or milk powder dispenser in accordance with the present invention has a milk bottle-installation stand in the front portion of the dispenser bottom-front 15, the stand being integrally formed with the dispenser bottom-front 15, and a carrying case-installation stand on the milk bottle-installation stand, the carrying case-installation stand being hingeably openable and closeable toward the inside of the dispenser bottom-front 15, 16. In this connection, one side of the carrying case-installation stand is hingeably attached to the inside of the dispenser bottom-front 15, 16. Similar to the former embodiment, the milk bottle-installation stand is provided with a guide groove integrally formed therein, such that the inlet of the milk bottle is in line with the dispenser outlet 15d. The carrying case-installation stand is also provided with a guide groove integrally formed therein, such that the inlet of the carrying case is in line with the dispenser outlet 15d.

In the powder or milk powder dispenser, when it is desired to employ the carrying case, the carrying case is pushed into the carrying case-installation stand. When it is desired to employ the milk bottle, the carrying case is pushed into the inside of the dispenser bottom-front 15, 16 and the milk bottle is then installed into the milk bottle-installation stand.

Individual components of the powder or milk powder dispenser in accordance with the present invention are preferably prepared using a polyamide material that does not discharge toxic substances even when they are disinfected in boiling water. Alternatively, the individual components may also be made of a polypropylene material which is not fragile, is light and transparent, and therefore allows visual confirmation of the cleanliness of the device. Further, the milk powder container 7 may be made to have transparent and soft color tones, thereby providing advantages that allow direct visual confirmation of the residual amount of milk powder and achieve attractive designs of products.

Assembly of Dispenser Bottom-Front 15, 16 and Dispenser Top Cover 12

FIGS. 15A and 15B are assembly diagrams of the dispenser bottom-front 15, 16 and the dispenser top cover 12.

As shown in FIGS. 15A and 15B, the dispenser top cover 12 (dispenser body) is fitted into the upper end of the dispenser bottom-front 15, 16. In this connection, the assembly of the dispenser bottom-front 15, 16 and the dispenser top cover 12 results in coaxial positioning of the outlet 14c of the dispenser tray nozzle 14 with the dispenser outlet 15d of the dispenser bottom-front 15.

Assembly of Dispenser Top Cover 12 and Milk Powder Container 7

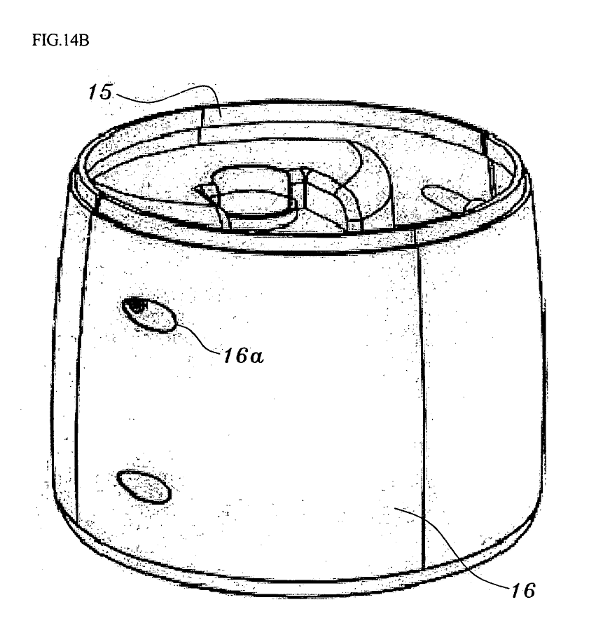

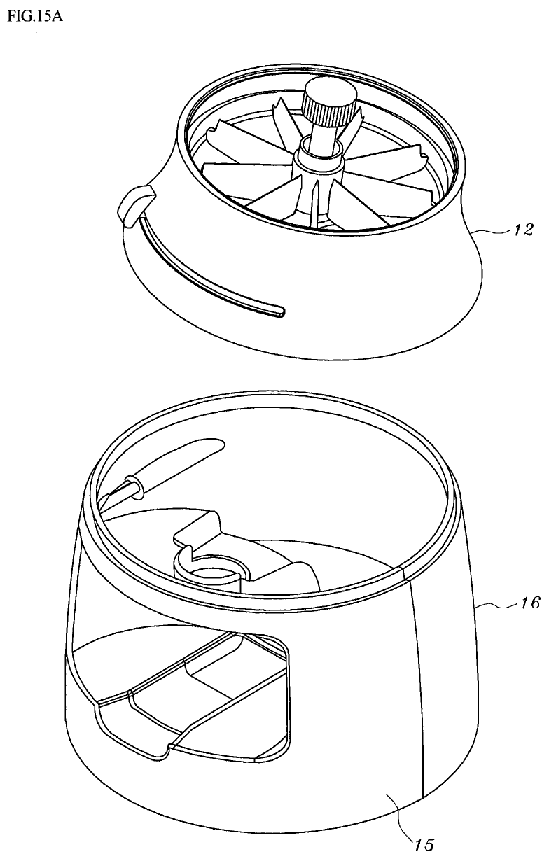

FIGS. 16A through 16C are assembly views of a dispenser top cover and a milk powder container.

As shown in FIGS. 16A through 16C, the milk powder container 7 is configured to have an open-topped and open-bottomed cylindrical structure made of a transparent colored material, and has graduations on one side thereof. The upper part of the milk powder container 7 is sealed hermetically by a milk powder container cap 5 with an O-ring and the lower part of the milk powder container 7 is sealed hermetically with the dispenser top cover 12 by a milk powder container seal 8.

The milk powder container seal 8 is mounted on the lower part of the milk powder container 7 which is then coupled to the upper part of the dispenser top cover 12. Here, inflow of air is blocked between the milk powder container 7 and the dispenser top cover 12 which are in airtight contact via installation of the milk powder container seal 8.

Next assembling of the powder or milk powder dispenser is completed by putting the milk powder container cap 5 on the upper part of the milk powder container 7. The milk powder container cap 5 is provided with the milk powder container cap O-ring 6 which provides airtight contact between the milk powder container 7 and the milk powder container cap 5, thereby blocking the inflow of air.

How to Use Powder or Milk Powder Dispenser

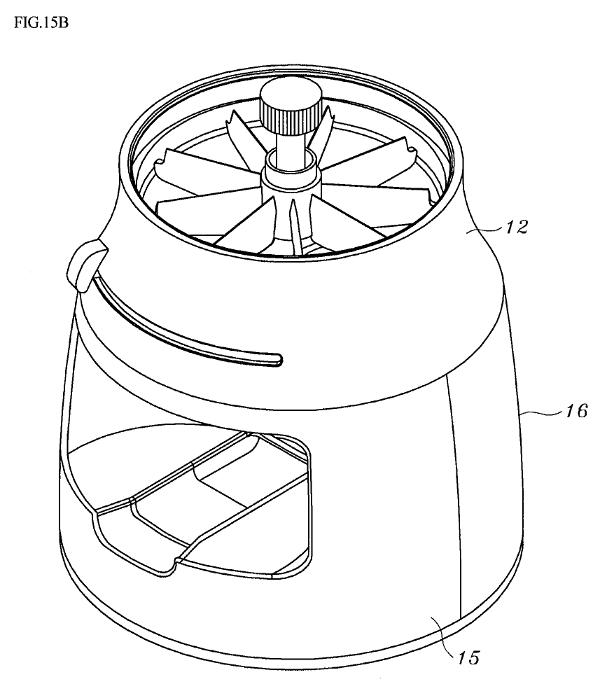

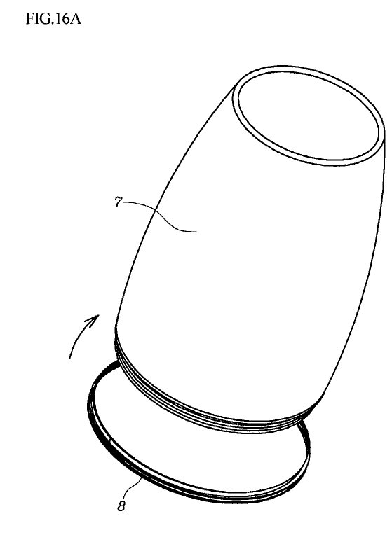

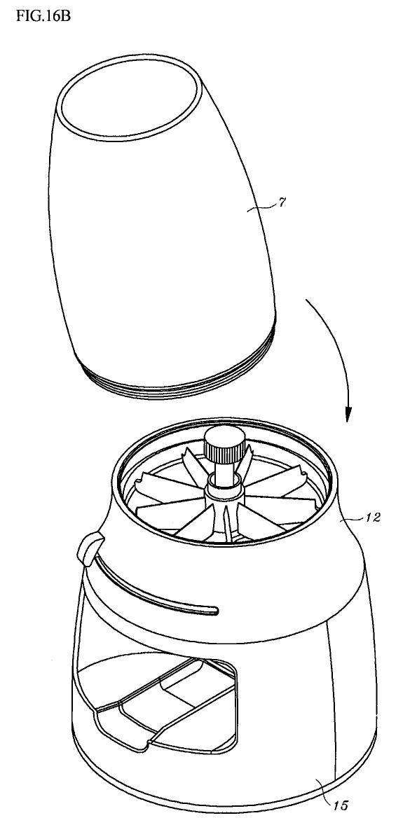

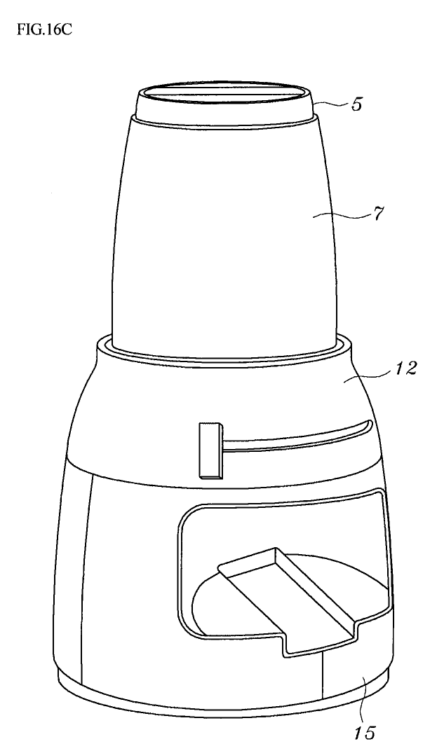

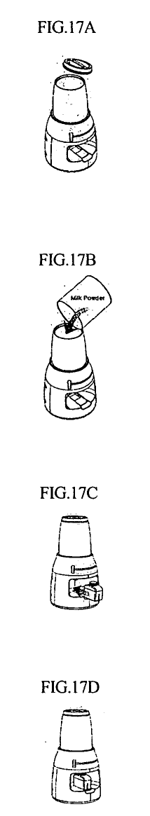

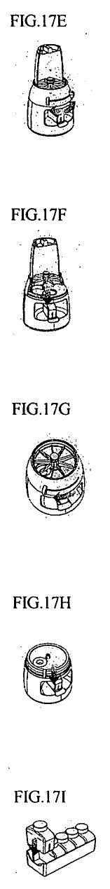

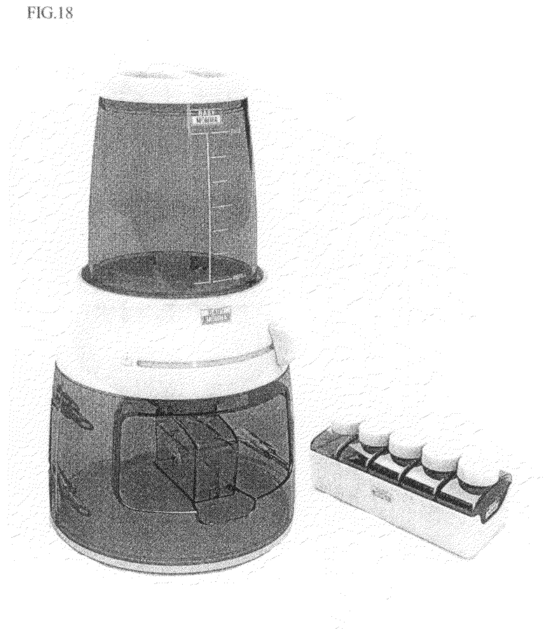

FIGS. 17A through 17I are explanatory diagrams illustrating how to use a powder or milk powder dispenser in accordance with the present invention.

Hereinafter, how to use the powder or milk powder dispenser of the present invention will be described.

First, the milk powder container cap 5 is removed, and a desired milk powder is filled into the milk powder container 7 which is then capped with the milk powder container cap 5 (see FIGS. 7A and 7B). Here, a funnel may be used to prevent leakage of milk powder to the outside.

Next the carrying case 30 with an assembly of the carrying case top 2 and carrying case bottom 3 is pushed into the installation stand 15f of the dispenser bottom-front 15, such that the inlet of the carrying case 30 is in line with the dispenser outlet 23 of the dispenser bottom-front 15 (see FIGS. 7C and 7D).

Next, the tray handle 21 of the dispenser top cover 12 is completely pushed to one side direction (for example, right side) and is then returned to the original position (left side) (see FIGS. 7E to 7H). When the tray handle 21 is completely pushed to the right side, an amount of milk powder corresponding to the capacity of the milk powder-measuring cup 20 mounted on the dispenser tray 13 falls to the inside of the carrying case 30 to thereby introduce a spoonful of milk powder (see FIGS. 17F and 17G). On the other hand, when the tray handle 21 is pulled to the original position (for example, left side), returning of the dispenser tray 13 to the original position leads to an inflow of milk powder in the milk powder container 7 into the milk powder-measuring cup 20 to thereby charge a spoonful of milk powder (see FIG. 17F).

By repeating the above-mentioned procedure, it is possible to fill an amount of milk powder corresponding to the spooning number of the same capacity into the carrying case 30.

The milk powder filled in the carrying case 30 can be simply and conveniently used when it is needed at home. Filling and storage of milk powder in the carrying case 30 are easy for going out (see FIG. 17I).

Product Photograph

FIG. 18 is a product photograph of a powder or milk powder dispenser.

As can be seen from the product photograph of the powder or milk powder dispenser in accordance with the present invention, the milk powder container 7 for containing and storing milk powder is installed at the uppermost end of the dispenser, the dispenser body (or dispenser top cover 12) provided with the tray handle 21 is installed at the lower end of the container 7, and the dispenser bottom-front 15, 16 for discharging the milk powder from the dispenser body to a carrying case 30 is installed at the lower end of the dispenser body.

Therefore, when the tray handle 21 is completely pushed to one side direction and is then returned to the original position, an amount of milk powder corresponding to the capacity of the milk powder-measuring cup 20 mounted on the dispenser tray 13 falls to the inside of the carrying case 30 to thereby introduce a spoonful of milk powder, and the milk powder in the milk powder container 7 is introduced into the milk powder-measuring cup 20 to thereby charge a spoonful of milk powder. By repeating such a procedure, it is possible to fill an amount of milk powder corresponding to the spooning number of the same volume into the carrying case 30.

As apparent from the above description, the powder or milk powder dispenser in accordance with the present invention provides the following effects:

1. Convenient dispensing of a precise amount of a milk powder to a carrying case and a milk bottle, without using hands or milk powder spoons.

2. Easy hygienic management due to no need to touch a milk powder spoon.

3. Keeping the health of infants due to the capability to prevent invasion of various pathogenic bacteria by removing risk factors from hands and milk powder spoons.

4. Exclusion of diarrhea and constipation of infants by formulation of a proper amount of milk powder.

5. Protection of milk powder against penetration of moisture or foreign materials in the air or invasion of insects, due to storage of milk powder in an airtight and dedicated milk powder container.

6. Easy visual confirmation of a residual amount of milk powder due to use of graduated semi-transparent milk powder container.

7. Easy washing of a dispenser due to easy assembly and disassembly of all components.

8. Measuring and dispensing of a constant and precise amount of milk powder, irrespective of using products of any milk powder manufacturer.

9. Measuring of an accurate proper amount of milk powder by a rotating handle.

10. A capability to dispense, store and carry a single dose of milk powder in each carrying case.

11. For easy carrying, a carrying case has a small volume, excellent durability, light weight and transparency, and therefore allows visual confirmation of cleanliness and the residual amount of milk powder.

12. A powder or milk powder dispenser can be dried using a carrying case holder after washing of a carrying case, due to the formation of a plurality of holes into which the carrying case can be inserted reversely when the carrying case holder is turned upside down.

13. A powder or milk powder dispenser has a variety of soft color tones and is made of a non-fragile polypropylene material.

14. A powder or milk powder dispenser employs a polyamide material that does not discharge a toxic substance even when it is disinfected in boiling water.

15. A powder or milk powder dispenser can be used to measure and discharge a proper amount of a given powdered material such as coffee, adlay, uncooked food or drug powder, in addition to milk powder.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A powder or milk powder dispenser, comprising a milk powder container 7 for storing milk powder (or powder); a dispenser body installed at a lower end of the milk powder container 7, and discharging an amount of milk powder corresponding to a capacity of a milk powder-measuring cup 20 mounted inside the dispenser tray when a tray handle 21 is moved to one side direction and charging an amount of milk powder by an inflow of milk powder in the milk powder container 7 into the milk powder-measuring cup 20 when the tray handle 21 is returned to the original position; and a dispenser bottom-front 15, 16 installed at a lower end of the dispenser body and discharging the milk powder from the dispenser body to an inlet of a carrying case 30 or a milk bottle.

2. The dispenser according to claim 1, wherein the dispenser body includes a cylindrical dispenser top cover 12 having a bottom surface 12e with a pipe shaft 12a and an outlet 12b integrally formed therein and having a tray handle movement slit 12c formed on the side thereof; a dispenser tray nozzle 14 installed at the lower part of the dispenser top cover 12 and having an outlet 14c provided at a position different from that of the outlet 12b of the dispenser top cover 12; a dispenser tray 13 charging/discharging the milk powder to the milk powder-measuring cup 20 while rotating between the outlet 12b of the dispenser top cover 12 and the outlet 14c of the dispenser tray nozzle 14 by the means of the tray handle 21 moving along the tray handle movement slit 12c; and a blade 11 installed at the upper part of the dispenser top cover 12 and mixing the milk powder of the milk powder container 7 by rotation of fans when the dispenser tray 13 rotates in one direction.

3. The dispenser according to claim 2, wherein the dispenser top cover 12 includes a body 12d having a cylindrical shape which is broad at the bottom and narrow on the top, space portions on the upper and lower parts being integrally formed with a bottom surface 12e at an inner central part, a pipe shaft 12a protrusively formed at the center of the upper and lower parts of the bottom surface 12e wherein the shaft formed at the lower part is partially incised with the formation of an inward screw, an outlet 12b formed on the bottom surface of one side of the pipe shaft 12a, a tray handle movement slit 12c lengthwise formed in a horizontal direction on the side of the body 12d, and inward protrusion portions of 12d in the body 12d opposite to the tray handle movement slit 12c.

4. The dispenser according to claim 3, wherein the dispenser body further includes a circular dispenser top seal 18 which is ringed about the lower part of the outlet 12b of the dispenser top cover 12.

5. The dispenser according to claim 4, wherein the dispenser tray 13 includes a circular body 13g having a shaft hole 13a at the center, a milk powder-measuring cup insertion hole 13d on one side and a tray handle insertion slot 13f on the rim of one side; a cylinder-shaped central shaft 13b positioned within the shaft hole 13a of the body 13g via integral connection of one side thereof to the body 13g, the end and the inner part of one side being provided with a plurality of teeth 13c having a right triangle-shaped section and a screw; a cup placement groove 13h for safe placement of the milk powder-measuring cup 20 inside the milk powder-measuring cup insertion hole 13d; insertion slots 13e formed at two opposite sides of the cup placement groove 13h; and fixing grooves 13i formed on one side of the insertion slots 13e, wherein the central shaft 13b of the dispenser tray 13 is fitted into the pipe shaft 12a of the dispenser top cover 12 such that the dispenser tray 13 rotates in the right and left directions within the incised range of the shaft.

6. The dispenser according to claim 5, wherein the milk powder-measuring cup 20 includes a circular horizontal plate 20b having an outlet formed at the center and having engaging protrusions 20a formed on both opposite sides; and a circular discharge pipe 20c integrally formed at the outlet in the direction vertical to the horizontal plate 20b, wherein the engaging protrusions 20a of the milk powder-measuring cup 20 are engaged into the insertion slots 13e of the dispenser tray 13 and the cup 20 is turned to be fixed into the fixing grooves 13i.

7. The dispenser according to claim 6, wherein the blade 11 includes a first pipe shaft 11a having a plurality of fans 11d and a step portion 11f on one side; and a second pipe shaft 11b positioned in the inside of the first pipe shaft 11a via connection of the one side of the shaft 11b to the first pipe shaft 11a and having a plurality of teeth 11c having a right triangle-shaped section formed at an end of one side,
wherein the second pipe shaft 11b is inserted into the pipe shaft 12a of the dispenser top cover 12 such that the teeth 11c of the blade 11 are engaged with the right triangle-shaped teeth 13c formed on the central shaft 13b of the dispenser tray 13, so the right-angled parts (sides) of right triangle-shaped teeth 13c of the dispenser tray 13 rotate by engagement with inclined parts (sides) of the right triangle-shaped teeth 11c of the blade 11 when the dispenser tray 13 rotates in a first direction, and therefore the blade 11 is not rotated by the elastic force of a spring 10 installed inside a blade holder 9 and the frictional force with the milk powder of the milk powder container 7,
when the dispenser tray 13 rotates in a second direction, the right-angled parts (sides) of right triangle-shaped teeth 13c of the dispenser tray 13 rotate while pushing right-angled parts (sides) of the right triangle-shaped teeth 11c of the blade 11.

8. The dispenser according to claim 7, wherein the dispenser body further includes a spring 10 installed at the step portion 11f of the first pipe shaft 11a after insertion of the blade 11 into the pipe shaft 12a of the dispenser top cover 12; and a blade holder 9 for fixing the blade 11 and the dispenser tray 13 via connection of the blade 9 through the inside of the spring 10 and the first pipe shaft 11a to the central shaft 13b of the dispenser tray 13.

9. The dispenser according to claim 8, wherein the tray handle 21 is inserted into the tray handle insertion slot 13f of the dispenser tray 13 via the tray handle movement slit 12c of the dispenser top cover 12 and is then fixed by inserting a tray handle fixing pin 24 into the fixing groove 21c of the tray handle 21.

10. The dispenser according to claim 9, wherein the dispenser tray nozzle 14 includes a shaft hole 14a formed at the center for insertion of the nozzle into the pipe shaft 12a formed on the lower part of the dispenser top cover 12; a discharge funnel 14b formed on one side of the shaft hole 14a and guiding the milk powder discharged through the milk powder-measuring cup 20 to an outlet 23 of the dispenser bottom-front 15; a guide rail 14e for guiding a movement of the milk powder-measuring cup 20 mounted on the dispenser tray 13; and a position-fixing groove 14d for fixing a position of the nozzle 14 by insertion of the groove 14d into the protrusion 12d of the dispenser top cover 12, and further includes a dispenser tray holder 19 for connecting the nozzle to the pipe shaft 12a of the dispenser top cover 12 through the shaft hole 14a after installation of the dispenser tray nozzle 14.

11. The dispenser according to claim 10, wherein The dispenser body is configured to have a structure that the milk powder charged in the milk powder-measuring cup 20 is discharged downwardly by allowing the milk powder-measuring cup 20 and the discharge funnel 14b of the dispenser tray nozzle 14 to be positioned coaxially to each other when the tray handle 21 is pushed in one side direction, and the milk powder is introduced into the milk powder-measuring cup 20 by allowing the milk powder-measuring cup 20 and the outlet 12b of the dispenser top cover 12 to be positioned coaxially to each other when the tray handle 21 is pulled to an original position in the other side direction, and the milk powder of the milk powder container is stirred by rotation of the blade 11 when the tray handle 21 rotates in one side direction or the other opposite direction.

12. The dispenser according to claim 11, wherein the dispenser tray 13 discharges a given amount of the milk powder filled in the milk powder-measuring cup 20 while rotating between the outlet 12b of the dispenser top cover 12 and the discharge funnel 14b of the dispenser tray nozzle 14 in compliance with the rotation of the tray handle 21.

13. The dispenser according to claim 1, wherein the milk powder container 7 is configured to have an open-topped and open-bottomed cylindrical structure made of a transparent colored material and has graduations on one side thereof, wherein the upper part of the milk powder container 7 is sealed hermetically by a milk powder container cap 5 with an O-ring and the lower part of the milk powder container 7 is sealed hermetically with the dispenser top cover 12 by a milk powder container seal 8.

14. The dispenser according to claim 1, wherein the dispenser bottom-front 15, 16 includes a front side 15 and the rear side 16 of the dispenser bottom-front which are screw-fastened after fitting the lower ends of the front side 15 and the rear side 16 into a dispenser bottom cover 17, wherein the front side 15 of the dispenser bottom-front includes an installation stand 15f having a guide groove for guiding the carrying case 30 such that the inlet of the carrying case 30 is in line with the dispenser outlet 15d, and the dispenser outlet 15d for discharging milk powder into the inlet of the carrying case 30 installed on the installation stand 15f.

15. The dispenser according to claim 14, wherein the dispenser bottom-front 15, 16 further includes a cover installation stand 15e protrusively formed on both sides of the dispenser outlet 15d and a dispenser outlet cover 25 installed on the cover installation stand 15e for plugging the dispenser outlet 15d.

16. The dispenser according to claim 1, wherein the carrying case 30 includes a carrying case top 2 having an inlet for injecting milk powder, a carrying case bottom 3 being detachably fitted into the carrying case top 2 and having insertion slots 3a formed on both sides and a carrying case cap 1 for stopping the inlet of the carrying case top 2.

17. The dispenser according to claim 16, wherein the powder or milk powder dispenser is configured to have an open-topped quadrilateral box-like structure, wherein the lower surface has a plurality of shaft holes 4b, the dispenser includes a carrying case holder 4 having a plurality of protrusions 4a formed at regular intervals in both inner sides of the box,
when the carrying case 30 is stored in the carrying case holder 4, insertion grooves 3a of the carrying case 30 are fitted into the protrusions 4a of the carrying case holder 4, and
when the carrying case 30 is washed, the carrying case holder 4 is reversed such that the shaft hole 4b of the carrying case holder 4 is faced upward, the washed carrying case 30 is reversely fitted into the shaft hole 4b, followed by drying.

18. The dispenser according to claim 1, wherein the powder or milk powder dispenser is made of a polyamide material that does not discharge a toxic substance even when it is disinfected in boiling water.

19. The dispenser according to claim 1, wherein the milk powder-measuring cup 20 is configured to comply with the capacity of the milk powder spoon of milk powder manufacturers, and the capacity of the milk powder-measuring cup 20 corresponds to a spoonful of the milk powder spoon of milk powder manufacturers.

20. The dispenser according to claim 1, wherein the capacity of the milk powder-measuring cup 20 corresponds to a single dose of the milk powder.

21. The dispenser according to claim 15, wherein the carrying case 30 includes a carrying case top 2 having an inlet for injecting milk powder, a carrying case bottom 3 being detachably fitted into the carrying case top 2 and having insertion slots 3a formed on both sides, and a carrying case cap 1 for stopping the inlet of the carrying case top 2.
